(19) United States
(12) Patent Application Publication
(10) Pub. No.: US 2009/0107524 A1
(43) Pub. Date: Apr. 30, 2009

(54) Surface-Modification Compositions

(75) Inventors: Stephen Gross, Souderton, PA (US); Susan Thomas, Philadelphia, PA (US); Timothy Morris, Morton, PA (US)

Correspondence Address: FOX ROTHSCHILD LLP, 2000 MARKET STREET, PHILADELPHIA, PA, 19103, US

(73) Assignee: Cognis IP Management GmbH, Duesseldorf (DE)

(21) Appl. No.: 12/239,773

(22) Filed: Sep. 27, 2008

Related U.S. Application Data
(60) Provisional application No. 60/975,541, filed on Sep. 27, 2007.

(51) Int. Cl. C11D 17/00; B08B 7/04

(52) U.S. Cl. 134/7; 510/418; 977/902

(57) ABSTRACT

Cleaning compositions with improved rinsing properties which provide a surface with reduced spotting after rinsing are provided. The preferred compositions contain at least one surfactant selected from the group consisting of anionic surfactants, nonionic surfactants and combinations thereof; inorganic nanoparticles; a carrier dispersible polymer containing cationic, anionic and nonionic residues; and a carrier, preferably water. Methods for cleaning including applying to a surface a cleaning composition of the invention, and rinsing the surface, preferably with water, is also provided.

### CROSS-REFERENCE TO RELATED APPLICATIONS

This application claims priority under 35 U.S.C. § 119(e) to U.S. Provisional Application 60/975,541, filed Sep. 27, 2007, the entire contents of which are hereby incorporated by reference herein.

### BACKGROUND OF THE INVENTION

1. Field of the Invention

The invention relates generally to cleaning compositions, and in preferred embodiments to cleaning compositions for hard surfaces that provide a sheeting effect for water run-off during the rinsing.

2. Background Information

Hard surface cleaners preferably provide a run-off of the rinsing water in a continuous film or sheet form. In a continuous film or sheet form, the run-off of the rinse water may be relatively slow, but does not remain on a surface in the form of droplets. Instead, rinse water drains from the surface in a continuous film with little or no individual droplets of the solution remaining. The advantage of this “sheeting effect” is that very few spots, and preferably essentially no spots, appear on the dried surface. This is advantageous because water droplets remaining on the surface generally leave a visible residue after drying, due to non-volatile components dissolved or dispersed in the water that remain on the surface after the water evaporates.

It is difficult to achieve the desired sheeting effect, however, due to the hydrophobic nature of many hard surfaces, which may be coated with a hydrophobic material, for example, polyurethane. For example, car panels may have a hydrophobic surface, consisting of a polyurethane “Clear-Coat”. Without any surface treatment, water beads tend to form on the surface of the panel, which exhibit a high contact angle, for example, about 100°. When the untreated panel is held at an angle other than horizontal, rinse water rolls off quickly, so the time required for one-half of the surface to dry is very fast, i.e., 1 to 2 seconds.

There remains a need for a hard surface cleaner with improved rinsing properties which conditions or modifies the surface so as increase the tendancy of rinse water run-off in the form of a sheet, instead of in the form of individual droplets.

### SUMMARY OF THE INVENTION

One aspect of the present invention provides a composition for cleaning, preferably for cleaning hard surfaces, which includes (a) at least one surfactant selected from the group consisting of nonionic surfactants, amphoteric surfactants, and combinations (preferably mixtures) thereof; (b) inorganic nanoparticles, preferably silica nanoparticles; (c) at least one polymer having at least one cationic moiety or residue, at least one anionic moiety or residue, and at least one nonionic moiety or residue, said polymer being at least partially dispersible in the carrier fluid of the composition, preferably water; and (d) a carrier fluid, preferably water.

Another aspect of the invention provides a method for cleaning a surface, particularly a hard surface, comprising: applying to the surface a cleaning composition including: (a) at least one surfactant selected from the group consisting of nonionic surfactants, amphoteric surfactants, and mixtures thereof; (b) silica nanoparticles; (c) a polymer containing at least one cationic moiety or residue, at least one anionic moiety or residue, and at least one nonionic moiety or residue, said polymer being at least partially dispersal in the carrier fluid of the composition, preferably water dispersible and carrier fluid, preferably water; and rinsing the surface with water.

### DETAILED DESCRIPTION OF PREFERRED EMBODIMENTS

Applicants have unexpectedly discovered that certain compositions according to the present invention produce exceptional and surprisingly superior results as cleaning and/or rinse-enhancing compositions. The preferred compositions comprise at least one surfactant selected from the group consisting of nonionic surfactants, amphoteric surfactants, and combinations of these; at least one group of nano-scale silica particles; water; and at least one polymer containing cationic, anionic and nonionic residues, wherein the polymer is at least partially dispersed, and preferably fully dispersed, in said water

In one aspect of the invention, the present compositions are applied to the surface to be cleaned, or which is being or has been cleaned, and when the surface is rinsed-off, preferably with water, the liquid run-off is in the form of a sheet with relatively few, and preferably substantially no, individual droplets remaining on the rinsed surface. In certain preferred embodiments, the surface being cleaned is a relatively hard surface, and even more preferably a hydrophobic surface, and even more preferably a hard, hydrophobic surface. According to preferred operations in accordance with the present invention, when the cleaned surface is dried, the surface is essentially spot-free.

As mentioned above, the present composition comprises at least one surfactant. The surfactant is preferably selected from the group of nonionic surfactants, amphoteric surfactants, or a combination of two or more of such surfactants. Preferred surfactants have hydrotroping activity and good wetting properties, but have low reactivity, and even more preferably substantially no reactivity, with the inorganic nano-particles, preferably with the silica nanoparticles and the water-dispersible polymer under conditions of formulation, packaging and use. Sugar surfactants and amphoteric surfactants are particularly useful in the practice of certain preferred embodiments of the invention. In view of the teachings contained herein, it is contemplated that those skilled in the art will be able to select a particular amphoteric surfactant, or a combination of amphoteric surfactants, for use in a wide variety of particular applications. In certain preferred embodiments, the present compositions comprise one or more amphoteric surfactants, including in preferred embodiments disodium n-alkyl-β-amino-dipropionates, and/or sugar surfactants, including Glucopon® 225 DK (a C₈₋₁₀ alkyl polyglucoside having a degree of polymerization of about 1.7), since such surfactants have been shown to be particularly useful in certain applications. Amphoteric surfactants as used herein may also include betaines, although betaines are not technically amphoteric. Alkylglycosides with an alkyl group containing from 6 to 18 carbon atoms and a degree of polymerization (DP) of from about 1.1 to 3, are commercially available from Cognis Corp and are preferred according to certain embodiments of the present invention.

Amphoteric and alkyl glycoside surfactants having good hydrotroping characteristics are particularly preferred. However, any amphoteric or nonionic surfactant having good wetting properties may be used. The surfactant component of the present invention, which is preferably selected from nonionic surfactants, amphoteric surfactants, and mixtures thereof, is preferably present in the composition in an amount of from about 0.1% to about 5% by weight, and even more preferably from about 0.5% to about 2% by weight of the cleaning and/or rinsing composition.

Although it is contemplated that a wide variety of silica nanoparticles are useful in connection with the present compositions and methods, in certain preferred embodiments it is preferred that the nanoparticles, preferably the silica nanoparticles, have an average particle size below about 1 micron. According to other preferred embodiments, the present compositions comprise nanoparticles, preferably silica nanoparticles, having an average particle size below about 500 nm, and even more preferably in certain embodiments below about 100 nm. In some of the most preferred embodiments, the nanoparticles, preferably the silica nanoparticles, contained in the present compositions have an average particle size of from about 2 to about 50 nm, and even more preferably, from about 3 to about 25 nm. Advantageously in certain embodiments, at least a portion, and in certain embodiments preferably all, of the silica nanoparticles are in the form of a silica sol that is readily admixed with the remaining components of the president cleaning compositions.

In general, it is contemplated that the present compositions may contain an amount of nanoparticles, preferably silica nanoparticles, over a wide range, and all such ranges are within the scope of the present invention. Nevertheless, in certain preferred embodiments, the compositions comprise silica nanoparticles in an amount of from about 0.01% to about 2% by weight of the composition, more preferably of from about 0.05 to about 1% by weight, and even more preferably of from about 0.1 to about 0.5% by weight of the composition.

As mentioned above, the present cleaning composition also includes a polymer, preferably a polymer having at least one cationic moiety or residue, at least one anionic moiety or residue, and at least one nonionic moiety or residue. It is contemplated that the polymer concentration according to the present compositions may vary widely according to the particular properties desired and uses contemplated, and that all such concentrations can be determined without undue experimentation in view of the teachings and guidance provided by the present application. In certain preferred embodiments, however, the polymer is present in the composition in an amount of from about 0.01% to about 2% by weight of the composition, and even more preferably of from about 0.1 to about 1% by weight of the composition.

In view of the teachings and guidance contained herein, it is contemplated that those skilled in the art will be able to select polymers for use in accordance with the particular needs of each application without undue experimentation. In certain preferred embodiments the polymer component having at least one cationic moiety or residue, at least one anionic moiety or residue, and at least one nonionic moiety or residue comprises a polymer of quarternary ammonium monomers, including in certain preferred embodiments homopolymers and/or copolymers of such monomers or of such monomers and other non-quanternary monomers. Monomers and polymers of this general type, or other types which may be adapted in certain circumstances for use in accordance with the present, are disclosed in each of the following United States Patents or Published Applications: U.S. Pat. No. 4,495,367; U.S. Pat. No. 4,973,637; U.S. Pat. No. 5,863,526; and U.S. Published Application US 2006/0205827. Each of the documents identified in the preceding sentence is incorporated fully herein by reference as if fully set forth in its entirety below.

In certain embodiments the polymer component of the present compositions comprises trimethyl ammonium propyl methacrylamide sodium acrylate/ethyl acrylate polymer. An example of such polymer(s) which is readily adaptable for use in connection with the present invention is known and available under the trade designation Polyquart® Ampho 149 (Cognis, the assignee of the present invention). Mention may also be made of the sodium acrylate/acrylamidopropyltrimethylammonium chloride copolymer, sold under the trade designation Polyquart KE 3033 by the company Henkel. Another polymer suitable for use in connection with the present compositions, particularly in applications requiring stability and effectiveness over a wide pH range, for example between about 1 and 13, is the product sold under the trade designation Polyquart® PRO by Cognis Corp.

Although not wishing to be bound by any theory herein, applicants believe that at least in certain preferred embodiments the electronic charge structure (including the absence of charge in certain areas of the polymer) of the preferred polymers in accordance with the present invention interact in a surprising and highly beneficial, but yet unexpected, manner with the other components of the composition, including particularly the inorganic nano particulate material. For example, it is believed that in certain embodiments the cationic charge centers of the preferred polymers have a strong attraction to both the hard surface being cleaned/rinsed and the inorganic, preferably silica, nanoparticles. Such attraction encourages or urges the inorganic nanoparticles, particularly the silica nanoparticles, towards and/or into association with and/or attachment to the hard surface, which thereby at least temporarily modifies the surface. Furthermore it is believed that the polymer delays the release of the silica nanoparticles from the surface, thus enhancing and aiding the sheeting action not only in connection with each rinse cycle, but also over repeated rinsings. As illustrated by the examples which follow, compositions which are formulated without the preferred polymers of the present invention have a strong tendency to be easily removed (including any silica nanoparticles) even after a single rinsing. As a result, it is believed that in such modes of operation essentially all of the silica nanoparticles are washed away in the first application of rinse water. In contrast, when a hard surface is treated with a composition according to preferred aspects of the present invention, the surface is rendered more hydrophilic, the rinse water has a substantially greater tendency to form a continuous film or “sheet” (that is, a much improved sheeting effect), and the drying time is increased, preferably by up to 3 seconds or more. As a result, the preferred compositions and methods of the present invention produce rinsed and dried surfaces having a dramatically reduced incidence of spotting. In certain highly preferred embodiments, the rinsed and dried surface is an essentially spot-free surface.

The compositions may be formed in preferred embodiments by mixing the surfactant, the nanoparticles, and the polymer with water to provide a composition with a suitable concentration. The resulting composition may be applied to a surface to be treated. The composition may be further diluted prior to treating a surface. A dilute composition may be utilized, since it is undesirable to provide a heavy coating to a surface (to avoid interfering with subsequent uses and treatments of the surface). After application, the surface may be dried before testing for the sheeting effect.

The composition according to an aspect of the invention may also be prepared as a concentrated aqueous dispersion containing about 10% of the inorganic nanoparticles, preferably silica nanoparticles, 25% by weight of a nonionic surfactant, an amphoteric surfactant, and combinations thereof, and 10% of a polymer in accordance with the present invention as described herein. The concentrate may then be mixed with the preferred carrier, preferably water, to provide a diluted cleaning solution which improves the sheeting action of the run-off water during the rinsing of a substrate surface.

### EXAMPLES

### Materials Used in the Examples

Polyquart® Ampho 149-A (PA 149), a polymer containing anionic, cationic and nonionic groups, available from Cognis Corp.

Glucopon® 225 DK—an alkyl glucoside having 8 to 10 carbon atoms in the alkyl group, and a glycoside moiety having a degree of polymerization of about 1.7, available from Cognis Corp.

Bindzil®, a silica sol (40% silica) average particle size 15 nm, a product of EKA Chemical Corp.

Deriphat® 160C—a 30% active amphoteric surfactant (sodium n-lauryl-beta-aminodipropionate) and a product of Cognis Corp.

### Examples 1-8

### Metal Panel Coated with a Hydrophobic Polyurethane Clear Topcoat

A composition was prepared as indicated below, applied to the surface of a polyurethane-coated metal panel representative of current automotive finishes, in a horizontal position, and permitted to dry. The dry panels were rinsed in a 45° position with water at a flow rate of about 4 liters per minute through a ¼ inch orifice.

The panels were coated at a central portion (test strip portion) with a composition according to an aspect of the invention. The areas on both sides of the test strip portion remained untreated. After drying, the panels were placed in a 45° position and rinsed with water. The time within which ½ of the treated section of the panel was free of water was measured. When no sheeting effect occurred, the drying time for ½ of the panel was relatively short (in the range of about 1-2 seconds). When the time for water to have cleared ½ of the panel was in the range of 3 or more seconds, a sheeting effect was present. Longer drying times for half of the surface of the panels indicated a more pronounced sheeting effect. In the Examples, it was found that the combination of an amphoteric surfactant, silica nanoparticles and a polymer containing anionic, cationic and nonionic groups provided the greatest sheeting effect when compared to compositions which do not contain either silica nanoparticles or the polymer. The results are indicated in Tables 1 and 2.

TABLE 1

| | Example | | | |
|---|---|---|---|---|
| | 1 | 2 | 3 | 4 |
| Dry Time for | Deriphat ® | Deriphat ® | Deriphat ® | Deriphat ® |
| Half the | 160C (1% | 160C (1% | 160C (1% | 160C (1% |
| Surface | act.) | act.) + | act.) + | act.) + |
| After: | | PA 149 | Bindzil ® | PA 149 (0.1% |
| | | (0.1% act) | (0.1% act.) | act.) + |
| | | | | Bindzil ® |
| | | | | (0.1% act.) |
| 1 rinse | 1 s | 20 s | 5 s | 300 s |
| 5 rinses | 1 s | 35 s | 6 s | 165 s |
| 20 rinses | 1 s | 45 s | 7 s | 170 s |
| Obser- | No | Sheeting | Sheeting | Pronounced |
| vations: | sheeting | present | present | sheeting |

TABLE 2

| | Example | | | |
|---|---|---|---|---|
| | 5 | 6 | 7 | 8 |
| Dry Time for | Glucopon ® | Glucopon ® | Glucopon ® | Glucopon ® |
| Half the | 225 DK | 225 DK (1% | 225 DK (1% | 225 DK (1% |
| Surface | (1% act.) | act.) + | act.) + | act.) + |
| After: | | PA 149 | Bindzil ® | PA 149 (0.1% |
| | | (0.1% act) | (0.1% act.) | act.) + |
| | | | | Bindzil ® |
| | | | | (0.1% act.) |
| 1 rinse | 1 s | 20 s | 3 s | 75 s |
| 5 rinses | 1 s | 15 s | 2 s | 65 s |
| 20 rinses | 1 s | 15 s | 2 s | 75 s |
| Obser- | No | Sheeting | Slight | More |
| vations: | sheeting | effect | sheeting | pronounced |
| | | present | effect | sheeting effect, |
| | | | quick drying | longer drying |
| | | | time | time |

Although the use of an amphoteric surfactant in combination with the polymer improved the sheeting effect, the Examples demonstrate a substantial improvement in the sheeting effect when the composition according to an aspect of the invention contained both the polymer, Polyquart® Ampho 149, and the silica nanoparticles, which improvement is greater than the addition of either of the individual additives, i.e., Polyquart® Ampho 149 or Bindzil®.

The combination of Polyquart® Ampho 149 and the Bindzil® silica nanoparticles exhibits a much more pronounced sheeting effect and thus a longer time for one-half of the treated surface to dry than either Polyquart® Ampho 149 or Bindzil® alone. In addition, the combination of Polyquart® Ampho 149 and Bindzil® yields drying times that are more than double than that of either additive alone.

The invention has been described with reference to specific embodiments. One of ordinary skill in the art, however, appreciates that various modifications and changes can be made without departing from the scope of the invention as set forth in the claims. For example, although Polyquart® Ampho 149 is exemplified, other suitable polymers may also be suitable for use according to the invention. Accordingly, the specification is to be regarded in an illustrative manner, rather than with a restrictive view, and all such modifications are intended to be included within the scope of the invention.

The benefits, advantages, and solutions to problems have also been described above with regard to specific embodiments. The benefits, advantages, and solutions to problems and any element(s) that may cause any benefit, advantage, or solution to occur or become more pronounced are not to be construed as a critical, required, or essential feature or element of any or all of the claims.

What is claimed is:

1. A composition for cleaning a hard surface, comprising:
(a) a surfactant selected from the group consisting of nonionic surfactants, amphoteric surfactants, and mixtures thereof;
(b) silica nanoparticles;
(c) a water-dispersible polymer containing cationic, anionic and nonionic residues; and
(d) water.

2. The composition according to claim 1, comprising from 0.1% to 5% by weight of the composition of a surfactant.

3. The composition according to claim 1, comprising from 0.01% to 2.0% by weight of silica nanoparticles.

4. The composition according to claim 1, comprising from 0.01% to 2% by weight of the water-dispersible polymer containing cationic, anionic and nonionic residues.

5. The composition according to claim 1, further diluted with water in a 2:1 to 20:1 ratio of water to composition, to provide an aqueous composition containing:
(a) 0.1% to 5% by weight of the surfactant;
(b) 0.01% to 2.0% by weight of silica nanoparticles; and
(c) 0.01% to 2.0% by weight of the water-dispersible polymer.

6. The composition according to claim 1, which upon contact with a hydrophobic surface, increases the surface drying time by at least 100%.

7. A method for cleaning a hard surface, comprising:
applying, to a hard surface, a cleaning composition comprising:
(a) a surfactant selected from the group consisting of nonionic surfactants, amphoteric surfactants, and mixtures thereof;
(b) silica nanoparticles;
(c) a water-dispersible polymer containing cationic, anionic and nonionic residues; and
(d) water; and
rinsing the hard surface with water to obtain an essentially spot-free surface.
